(19) United States
(12) Patent Application Publication
(10) Pub. No.: US 2026/0143426 A1
(43) Pub. Date: May 21, 2026

(54) METHODS, COMMUNICATIONS DEVICES, AND INFRASTRUCTURE EQUIPMENT

(71) Applicant: Sony Group Corporation, Tokyo (JP)

(72) Inventors: Martin Warwick BEALE, Basingstoke (GB); Samuel Asangbeng ATUNGSIRI, Basingstoke (GB); Shin Horng WONG, Basingstoke (GB)

(73) Assignee: Sony Group Corporation, Tokyo (JP)

(21) Appl. No.: 19/119,107

(22) PCT Filed: Nov. 1, 2023
(86) PCT No.: PCT/EP2023/080488

§ 371 Date: Apr. 8, 2025

(30) Foreign Application Priority Data
Nov. 4, 2022 (EP) 22205667.3

(51) Int. Cl. H04W 52/02; H04W 76/40

(52) U.S. Cl. CPC H04W 52/0235; H04W 76/40

(57) ABSTRACT

A method of operating a communications device comprising a low-power receiver and a main receiver comprising determining whether or not the communications device is to monitor for a first signal from a wireless communications network, wherein the first signal comprises an indication of timing information of the wireless communications network, receiving, if the communications device determines it is to monitor for the first signal, the first signal from the wireless communications network via the low-power receiver while the low-power receiver is in an on state and the main receiver is in an off state, and synchronising the communications device with the wireless communications network based on the timing information of the wireless communications network. Here, a power consumption of the low-power receiver when the low-power receiver is in the on state is lower than a power consumption of the main receiver when the main receiver is in the on state.

### BACKGROUND

### Field of Disclosure

The present disclosure relates to communications devices, infrastructure equipment and methods for the more effective power saving of communications devices in wireless communications networks.

The present application claims the Paris Convention priority from European Patent Application number EP22205667.3, filed on 4 Nov. 2022, the contents of which are hereby incorporated by reference.

### Description of Related Art

The “background” description provided herein is for the purpose of generally presenting the context of the disclosure. Work of the presently named inventors, to the extent it is described in this background section, as well as aspects of the description which may not otherwise qualify as prior art at the time of filing, are neither expressly or impliedly admitted as prior art against the present invention.

Previous generation mobile telecommunication systems, such as those based on the 3GPP defined UMTS and Long Term Evolution (LTE) architecture, are able to support a wider range of services than simple voice and messaging services offered by previous generations of mobile telecommunication systems. For example, with the improved radio interface and enhanced data rates provided by LTE systems, a user is able to enjoy high data rate applications such as mobile video streaming and mobile video conferencing that would previously only have been available via a fixed line data connection. The demand to deploy such networks is therefore strong and the coverage area of these networks, i.e. geographic locations where access to the networks is possible, is expected to continue to increase rapidly.

Current and future wireless communications networks are expected to routinely and efficiently support communications with an ever-increasing range of devices associated with a wider range of data traffic profiles and types than existing systems are optimised to support. For example, it is expected future wireless communications networks will be expected to efficiently support communications with devices including reduced complexity devices, machine type communication (MTC) devices, high resolution video displays, virtual reality headsets, extended Reality (XR) and so on. Some of these different types of devices may be deployed in very large numbers, for example low complexity devices for supporting the “The Internet of Things”, and may typically be associated with the transmissions of relatively small amounts of data with relatively high latency tolerance. Other types of device, for example supporting high-definition video streaming, may be associated with transmissions of relatively large amounts of data with relatively low latency tolerance. Other types of device, for example used for autonomous vehicle communications and for other critical applications, may be characterised by data that should be transmitted through the network with low latency and high reliability. A single device type might also be associated with different traffic profiles/characteristics depending on the application(s) it is running. For example, different consideration may apply for efficiently supporting data exchange with a smartphone when it is running a video streaming application (high downlink data) as compared to when it is running an Internet browsing application (sporadic uplink and downlink data) or being used for voice communications by an emergency responder in an emergency scenario (data subject to stringent reliability and latency requirements).

In view of this there is expected to be a desire for current wireless communications networks, for example those which may be referred to as 5G or new radio (NR) systems/new radio access technology (RAT) systems, or indeed future 6G wireless communications, as well as future iterations/releases of existing systems, to efficiently support connectivity for a wide range of devices associated with different applications and different characteristic data traffic profiles and requirements.

One example of a new service is referred to as Ultra Reliable Low Latency Communications (URLLC) services which, as its name suggests, requires that a data unit or packet be communicated with a high reliability and with a low communications delay. Another example of a new service is enhanced Mobile Broadband (eMBB) services, which are characterised by a high capacity with a requirement to support up to 20 Gb/s. URLLC and eMBB type services therefore represent challenging examples for both LTE type communications systems and 5G/NR communications systems.

5G NR has continuously evolved and the current work plan includes 5G-NR-advanced in which some further enhancements are expected, especially to support new use-cases/scenarios with higher requirements. The desire to support these new use-cases and scenarios gives rise to new challenges for efficiently handling communications in wireless communications systems that need to be addressed.

### SUMMARY OF THE DISCLOSURE

The present disclosure can help address or mitigate at least some of the issues discussed above.

Embodiments of the present technique can provide a method of operating a communications device comprising a low-power receiver and a main receiver. The method comprises determining whether or not the communications device is to monitor for a first signal from a wireless communications network, wherein the first signal comprises an indication of timing information of the wireless communications network, receiving, if the communications device determines it is to monitor for the first signal, the first signal from the wireless communications network via the low-power receiver while the low-power receiver is in an on state and the main receiver is in an off state, and synchronising the communications device with the wireless communications network based on the timing information of the wireless communications network. Here, a power consumption of the low-power receiver when the low-power receiver is in the on state is lower than a power consumption of the main receiver when the main receiver is in the on state.

Embodiments of the present technique, which, in addition to methods of operating communications devices, relate to methods of operating infrastructure equipment, communications devices and infrastructure equipment, circuitry for communications devices and infrastructure equipment, computer programs, and computer-readable storage mediums, can allow for the more effective power saving of communications devices operating in a wireless communications network.

Respective aspects and features of the present disclosure are defined in the appended claims.

It is to be understood that both the foregoing general description and the following detailed description are exemplary, but are not restrictive, of the present technology. The described embodiments, together with further advantages, will be best understood by reference to the following detailed description taken in conjunction with the accompanying drawings.

### BRIEF DESCRIPTION OF THE DRAWINGS

A more complete appreciation of the disclosure and many of the attendant advantages thereof will be readily obtained as the same becomes better understood by reference to the following detailed description when considered in connection with the accompanying drawings wherein like reference numerals designate identical or corresponding parts throughout the several views, and wherein:

FIG. 1 schematically represents some aspects of an LTE-type wireless telecommunication system which may be configured to operate in accordance with certain embodiments of the present disclosure;

FIG. 2 schematically represents some aspects of a new radio access technology (NR) wireless telecommunications system which may be configured to operate in accordance with certain embodiments of the present disclosure;

FIG. 3 is a schematic block diagram of an example infrastructure equipment and communications device which may be configured to operate in accordance with certain embodiments of the present disclosure;

FIG. 4 is a graphical plot of user equipment (UE) processing activity against time illustrating an example of a discontinuous reception (DRX) cycle;

FIG. 5 is a graphical plot of UE processing activity against time illustrating an example of a paging occasion preceded by a wake-up signal according to that used for LTE;

FIG. 6 is a graphical plot of UE processing activity against time illustrating an example of a DRX cycle according to that used for 5G/NR;

FIG. 7 illustrates the relationship between a main receiver (MR) and a lower power receiver (LP-WUR) of a UE which may be configured to operate in accordance with certain embodiments of the present disclosure;

FIG. 8 shows an example of how a low-power wake-up signal (LP-WUS) may be monitored for by an LP-WUR of a UE prior to a paging occasion;

FIG. 9 illustrates how the length of an LP-WUS monitoring window at a UE may increase with time due to timing drift of the UE's LP-WUR;

FIG. 10 shows a part schematic, part message flow diagram representation of a wireless communications system comprising a communications device and an infrastructure equipment in accordance with embodiments of the present technique; and

FIG. 11 shows a flow diagram illustrating a process of communications in a communications system in accordance with embodiments of the present technique.

### DETAILED DESCRIPTION OF THE EMBODIMENTS

### Long Term Evolution Advanced Radio Access Technology (4G)

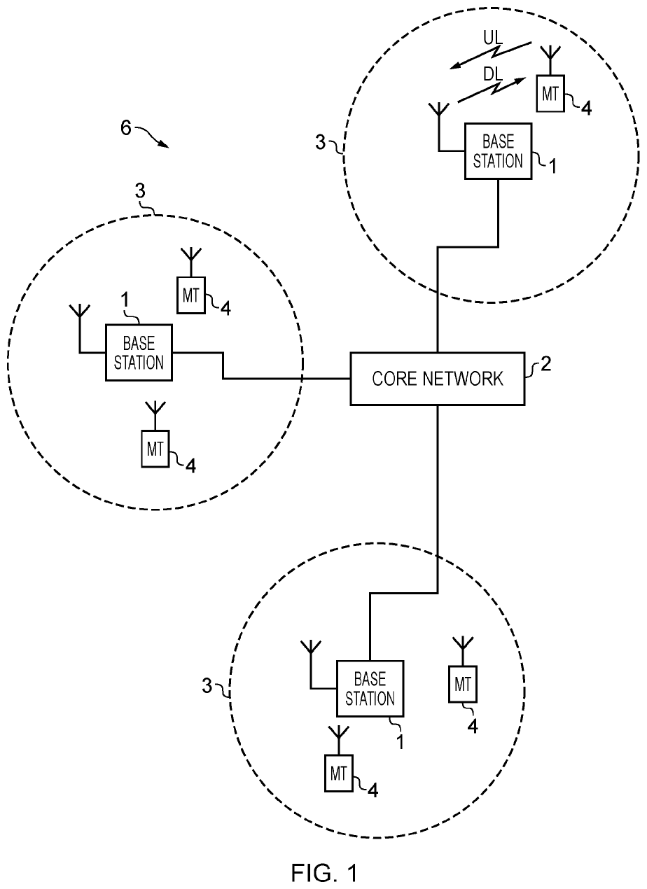

FIG. 1 provides a schematic diagram illustrating some basic functionality of a mobile telecommunications network/system 6 operating generally in accordance with LTE principles, but which may also support other radio access technologies, and which may be adapted to implement embodiments of the disclosure as described herein. Various elements of FIG. 1 and certain aspects of their respective modes of operation are well-known and defined in the relevant standards administered by the 3GPP (RTM) body, and also described in many books on the subject, for example, Holma H. and Toskala A [1]. It will be appreciated that operational aspects of the telecommunications networks discussed herein which are not specifically described (for example in relation to specific communication protocols and physical channels for communicating between different elements) may be implemented in accordance with any known techniques, for example according to the relevant standards and known proposed modifications and additions to the relevant standards.

The network 6 includes a plurality of base stations 1 connected to a core network 2. Each base station provides a coverage area 3 (i.e. a cell) within which data can be communicated to and from communications devices 4. Although each base station 1 is shown in FIG. 1 as a single entity, the skilled person will appreciate that some of the functions of the base station may be carried out by disparate, inter-connected elements, such as antennas (or antennae), remote radio heads, amplifiers, etc. Collectively, one or more base stations may form a radio access network.

Data is transmitted from base stations 1 to communications devices 4 within their respective coverage areas 3 via a radio downlink (DL). Data is transmitted from communications devices 4 to the base stations 1 via a radio uplink (UL). The core network 2 routes data to and from the communications devices 4 via the respective base stations 1 and provides functions such as authentication, mobility management, charging and so on. Communications devices may also be referred to as mobile stations, user equipment (UEs), user terminals, mobile radios, terminal devices, wireless transmit and receive units (WTRUs), and so forth. Services provided by the core network 2 may include connectivity to the internet or to external telephony services. The core network 2 may further track the location of the communications devices 4 so that it can efficiently contact (i.e. page) the communications devices 4 for transmitting downlink data towards the communications devices 4.

Base stations, which are an example of network infrastructure equipment, may also be referred to as transceiver stations, nodeBs, e-nodeBs, eNB, g-nodeBs, gNB and so forth. In this regard different terminology is often associated with different generations of wireless telecommunications systems for elements providing broadly comparable functionality. However, certain embodiments of the disclosure may be equally implemented in different generations of wireless telecommunications systems, and for simplicity certain terminology may be used regardless of the underlying network architecture. That is to say, the use of a specific term in relation to certain example implementations is not intended to indicate these implementations are limited to a certain generation of network that may be most associated with that particular terminology.

### New Radio Access Technology (5G)

Systems incorporating NR technology are expected to support different services (or types of services), which may be characterised by different requirements for latency, data rate and/or reliability. For example, Enhanced Mobile Broadband (eMBB) services are characterised by high capacity with a requirement to support up to 20 Gb/s. The requirements for Ultra Reliable and Low Latency Communications (URLLC) services are for one transmission of a 32 byte packet to be transmitted from the radio protocol layer 2/3 SDU ingress point to the radio protocol layer 2/3 SDU egress point of the radio interface within 1 ms with a reliability of 1−10⁻⁵ (99.999%) or higher (99.9999%) [2].

Massive Machine Type Communications (mMTC) is another example of a service which may be supported by NR-based communications networks. In addition, systems may be expected to support further enhancements related to Industrial Internet of Things (IIoT) in order to support services with new requirements of high availability, high reliability, low latency, and in some cases, high-accuracy positioning.

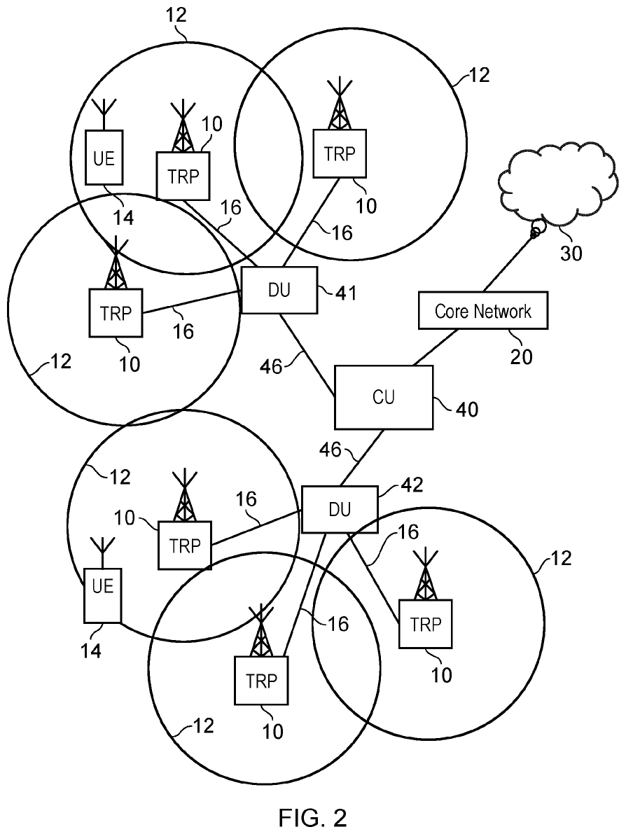

An example configuration of a wireless communications network which uses some of the terminology proposed for and used in NR and 5G is shown in FIG. 2. In FIG. 2 a plurality of transmission and reception points (TRPs) 10 are connected to distributed control units (DUs) 41, 42 by a connection interface represented as a line 16. Each of the TRPs 10 is arranged to transmit and receive signals via a wireless access interface within a radio frequency bandwidth available to the wireless communications network. Thus, within a range for performing radio communications via the wireless access interface, each of the TRPs 10, forms a cell of the wireless communications network as represented by a circle 12. As such, wireless communications devices 14 which are within a radio communications range provided by the cells 12 can transmit and receive signals to and from the TRPs 10 via the wireless access interface. Each of the distributed units 41, 42 are connected to a central unit (CU) 40 (which may be referred to as a controlling node) via an interface 46. The central unit 40 is then connected to the core network 20 which may contain all other functions required to transmit data for communicating to and from the wireless communications devices and the core network 20 may be connected to other networks 30.

The elements of the wireless access network shown in FIG. 2 may operate in a similar way to corresponding elements of an LTE network as described with regard to the example of FIG. 1. It will be appreciated that operational aspects of the telecommunications network represented in FIG. 2, and of other networks discussed herein in accordance with embodiments of the disclosure, which are not specifically described (for example in relation to specific communication protocols and physical channels for communicating between different elements) may be implemented in accordance with any known techniques, for example according to currently used approaches for implementing such operational aspects of wireless telecommunications systems, e.g. in accordance with the relevant standards.

The TRPs 10 of FIG. 2 may in part have a corresponding functionality to a base station or eNodeB of an LTE network. Similarly, the communications devices 14 may have a functionality corresponding to the UE devices 4 known for operation with an LTE network. It will be appreciated therefore that operational aspects of a new RAT network (for example in relation to specific communication protocols and physical channels for communicating between different elements) may be different to those known from LTE or other known mobile telecommunications standards. However, it will also be appreciated that each of the core network component, base stations and communications devices of a new RAT network will be functionally similar to, respectively, the core network component, base stations and communications devices of an LTE wireless communications network.

In terms of broad top-level functionality, the core network 20 connected to the new RAT telecommunications system represented in FIG. 2 may be broadly considered to correspond with the core network 2 represented in FIG. 1, and the respective central units 40 and their associated distributed units/TRPs 10 may be broadly considered to provide functionality corresponding to the base stations 1 of FIG. 1. The term network infrastructure equipment/access node may be used to encompass these elements and more conventional base station type elements of wireless telecommunications systems. Depending on the application at hand the responsibility for scheduling transmissions which are scheduled on the radio interface between the respective distributed units and the communications devices may lie with the controlling node/central unit and/or the distributed units/TRPs. A communications device 14 is represented in FIG. 2 within the coverage area of the first communication cell 12. This communications device 14 may thus exchange signalling with the first central unit 40 in the first communication cell 12 via one of the distributed units/TRPs 10 associated with the first communication cell 12.

It will further be appreciated that FIG. 2 represents merely one example of a proposed architecture for a new RAT based telecommunications system in which approaches in accordance with the principles described herein may be adopted, and the functionality disclosed herein may also be applied in respect of wireless telecommunications systems having different architectures.

Thus, certain embodiments of the disclosure as discussed herein may be implemented in wireless telecommunication systems/networks according to various different architectures, such as the example architectures shown in FIGS. 1 and 2. It will thus be appreciated the specific wireless telecommunications architecture in any given implementation is not of primary significance to the principles described herein. In this regard, certain embodiments of the disclosure may be described generally in the context of communications between network infrastructure equipment/access nodes and a communications device, wherein the specific nature of the network infrastructure equipment/access node and the communications device will depend on the network infrastructure for the implementation at hand. For example, in some scenarios the network infrastructure equipment/access node may comprise a base station, such as an LTE-type base station 1 as shown in FIG. 1 which is adapted to provide functionality in accordance with the principles described herein, and in other examples the network infrastructure equipment may comprise a control unit/controlling node 40 and/or a TRP 10 of the kind shown in FIG. 2 which is adapted to provide functionality in accordance with the principles described herein.

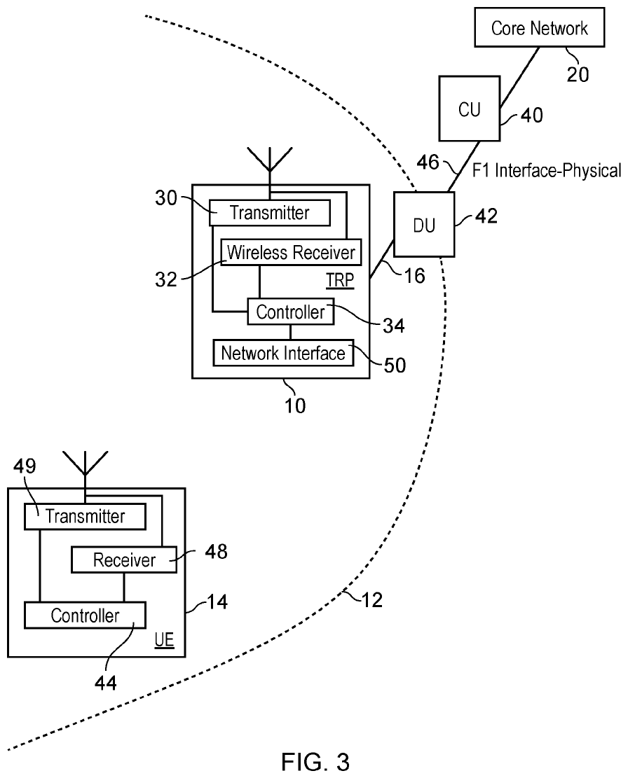

A more detailed diagram of some of the components of the network shown in FIG. 2 is provided by FIG. 3. In FIG. 3, a TRP 10 as shown in FIG. 2 comprises, as a simplified representation, a wireless transmitter 30, a wireless receiver 32 and a controller or controlling processor 34 which may operate to control the transmitter 30 and the wireless receiver 32 to transmit and receive radio signals to one or more UEs 14 within a cell 12 formed by the TRP 10. As shown in FIG. 3, an example UE 14 is shown to include a corresponding transmitter 49, a receiver 48 and a controller 44 which is configured to control the transmitter 49 and the receiver 48 to transmit signals representing uplink data to the wireless communications network via the wireless access interface formed by the TRP 10 and to receive downlink data as signals transmitted by the transmitter 30 and received by the receiver 48 in accordance with the conventional operation.

The transmitters 30, 49 and the receivers 32, 48 (as well as other transmitters, receivers and transceivers described in relation to examples and embodiments of the present disclosure) may include radio frequency filters and amplifiers as well as signal processing components and devices in order to transmit and receive radio signals in accordance for example with the 5G/NR standard. The controllers 34, 44 (as well as other controllers described in relation to examples and embodiments of the present disclosure) may be, for example, a microprocessor, a CPU, or a dedicated chipset, etc., configured to carry out instructions which are stored on a computer readable medium, such as a non-volatile memory. The processing steps described herein may be carried out by, for example, a microprocessor in conjunction with a random access memory, operating according to instructions stored on a computer readable medium. The transmitters, the receivers and the controllers are schematically shown in FIG. 3 as separate elements for ease of representation. However, it will be appreciated that the functionality of these elements can be provided in various different ways, for example using one or more suitably programmed programmable computer(s), or one or more suitably configured application-specific integrated circuit(s)/circuitry/chip(s)/chipset(s). As will be appreciated the infrastructure equipment/TRP/base station as well as the UE/communications device will in general comprise various other elements associated with its operating functionality.

As shown in FIG. 3, the TRP 10 also includes a network interface 50 which connects to the DU 42 via a physical interface 16. The network interface 50 therefore provides a communication link for data and signalling traffic from the TRP 10 via the DU 42 and the CU 40 to the core network 20.

The interface 46 between the DU 42 and the CU 40 is known as the F1 interface which can be a physical or a logical interface. The F1 interface 46 between CU and DU may operate in accordance with specifications 3GPP TS 38.470 and 3GPP TS 38.473, and may be formed from a fibre optic or other wired or wireless high bandwidth connection. In one example the connection 16 from the TRP 10 to the DU 42 is via fibre optic. The connection between a TRP 10 and the core network 20 can be generally referred to as a backhaul, which comprises the interface 16 from the network interface 50 of the TRP 10 to the DU 42 and the F1 interface 46 from the DU 42 to the CU 40.

In order for a UE such as UE 4 or 14 to transmit uplink data to the network (e.g. on a Physical Uplink Control Channel (PUCCH) or a Physical Uplink Shared Channel (PUSCH)) to, for example, base station 1 or TRP 10, the UE must first ensure it is synchronised with the network on the uplink. Since a particular eNB or gNB expects to be receiving communications from many UEs, it needs to ensure that it shares a common timing understanding with each of these UEs (i.e. they are synchronised in terms of the starting times of frames and Orthogonal Frequency Division Multiplexed (OFDM) symbols). This is so that the eNB is able to schedule communication with each of them in a manner that avoids collisions and to ensure orthogonality of the uplink signals, such that inter-subcarrier interference is avoided or mitigated.

### Power Saving and Discontinuous Reception (DRX) in NR

In a typical currently deployed network, communications devices can operate in a discontinuous reception (DRX) mode during which the communications devices wake-up (i.e. power-up their receivers) to receive signals during their DRX wake time. DRX operation can occur when the communications devices are in an idle mode or in a connected mode. In connected mode, the communications device is configured to periodically monitor physical downlink control channels (PDCCHs) in groups of slots or subframes. If a PDCCH with a Radio Network Temporary Identifier (RNTI) addressed to the communications device is not detected during the group of slots or subframes, the communications device may sleep for the next cycle of the periodicity. Power saving is an important aspect of a user's experience of such wireless radio access technologies such as NR, which will influence the adoption of 5G and future generation handsets and/or services. DRX is one method of power saving for NR communications devices.

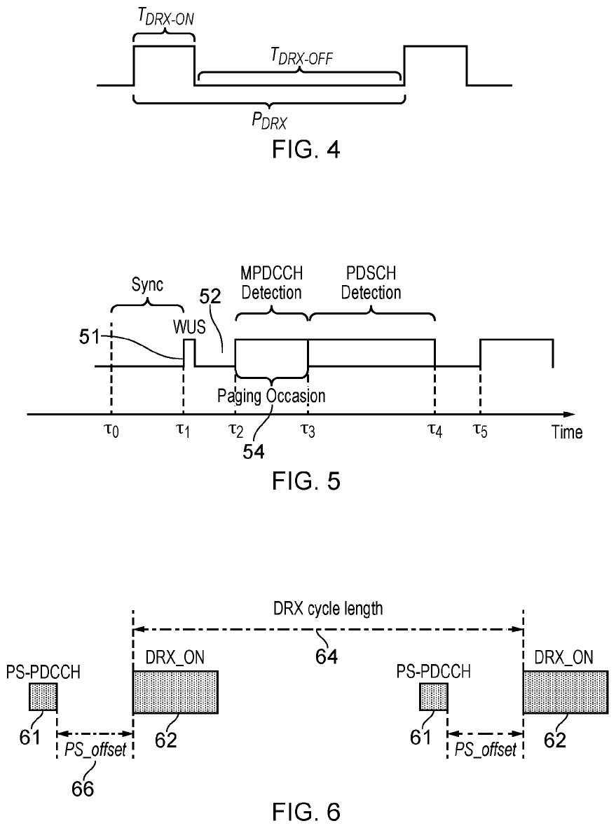

The basic DRX cycle is shown in FIG. 4, which consists of a DRX ON period of duration TDRX-ON and a period of inactivity, i.e. a DRX OFF period, of duration T_{DRX-OFF} where the DRX ON period occurs periodically at a DRX period, P_{DRX}. During the DRX ON period, the UE switches on its receiver to monitor for downlink traffic and switches off its receiver during the DRX OFF period to save power consumption. The DRX parameters T_{DRX-ON} & P_{DRX} are configured by the network. It should be appreciated by those skilled in the art that such a basic operation may not always be efficient, particularly if a UE frequently does not receive any signals during the ON period (or active operating mode) of the DRX operation.

### Wake-Up Signals to Save Power

There are a number of different ways in which the battery life of a UE may be improved. One such way is by enabling a DRX configuration to adapt to a UE's expected data reception or transmission profile.

For example, a Wake-Up Signal (WUS) may be used to indicate whether a UE should wake up during a DRX ON period. The WUS is a signal or a channel that is transmitted to a UE or a group of UEs prior to a DRX ON period or Paging Occasion (PO) to indicate whether the UE(s) needs to wake up during this ON period and monitor for possible traffic, e.g. monitor the PDCCH. Using a WUS signal in this way to wake-up a UE recognises that not every DRX ON period contains traffic for the UE, and for such a case, the PDCCH monitoring consumes unnecessary power from the UE, which can be avoided with this WUS signaling.

Wake-up signals are supported in technologies such as eMTC, NB-IoT and in 5G NR. The eMTC/NB-IoT wake-up signal (WUS) is used in IDLE mode before a paging occasion. If the UE detects a WUS, it wakes up and monitors the following paging occasion for an MTC PDCCH (MPDCCH) or an NB-IoT (NPDCCH) that may further allocate a paging message. If the UE does not receive a WUS, it can go back to sleep. The WUS consists of a known sequence. The UE can monitor for the WUS by performing a correlation against this known sequence. As indicated above, the WUS either can be common to all the UEs associated with the paging occasion, or can be associated with a group of UEs that are associated with the paging occasion.

An example of a WUS is illustrated by a timing diagram showing a plot of transmission power and UE receiver activity with respect to time provided in FIG. 5. As shown in FIG. 5, a wake-up signal WUS 51 occurs at a known time offset □2-□1 52 before a paging occasion 54. The time offset 52 allows the UE to “boot-up” its main receiver (MR) after WUS reception and before the paging occasion 54. As a result the WUS itself can be monitored with a lower power receiver, since the lower power receiver does not need to be able to receive all the features of the signal that the MR is able to receive. The WUS is transmitted prior to the paging occasion 54 as shown in FIG. 5 at time □₁, only when there is an MPDCCH transmission in that paging occasion. When the WUS is UE-specific (i.e. each UE has its own WUS), the WUS for that UE is only sent when there is an MPDCCH transmission in that paging occasion that is targeted at that UE. When the WUS is group-specific (i.e. a group of UEs share a WUS), the WUS for that group is sent when there is an MPDCCH in that paging occasion that is targeted to at least one of the UEs in that group. Upon detection of a WUS, the UE will proceed to-fine tune its frequency and timing tracking loops if required and blind detects for an MPDCCH between time □₂ and □₃ followed by decoding of the PDSCH carrying the paging message between time □₃ and □₄. If the UE fails to detect a WUS, it will go back to sleep and skip detecting for MPDDCH. Hence by using WUS, the UE will consume less energy by avoiding unnecessary monitoring of MPDCCH. It should be appreciated that WUS can also be used in connected mode when DRX is used.

In some examples, the WUS may be a physical channel containing very little information (e.g. UE ID or a single bit indicating that UEs monitoring that WUS should wake up) and so the UE can decode the WUS very quickly compared with blind decoding for MPDCCH. The WUS can also be encoded with a format that enables low power decoding; for example, the WUS may be a narrow bandwidth signal that can be decoded with low power using a low sampling rate receiver.

For the example of 5G NR, a wake-up signal WUS is used in CONNECTED mode DRX operation [3]. The 5G NR WUS is based on a PDCCH that carries Downlink Control Information (DCI). The PDCCH may be referred to as Power saving-PDCCH (PS-PDCCH), while the monitoring period for this PDCCH is referred to as a PS-PDCCH monitoring period. Here, the term PS-PDCCH is synonymous with “PDCCH that is scrambled with a PS-RNTI”. This monitoring period may also be referred to as a “power saving monitoring period”. The NR WUS is described in more detail in [4].

An example timing diagram illustrating a transmission of signals with respect to time for a 5G NR operation in a CONNECTED mode is shown in FIG. 6. As shown in FIG. 6, a PS-PDCCH 61 occurs in a search space before a DRX_ON phase 62 of a DRX cycle represented by a double headed arrow 64. This example represents one full CONNECTED mode DRX cycle. A temporal location of the PS-PDCCH 61 is in advance of the DRX_ON phase 62 by an amount PS_offset 66. A UE decodes the DCI within the PS-PDCCH. Since the UE only has to decode the PS-PDCCH, it does not have to operate its full receiver circuitry, and therefore PS-PDCCH can be decoded with a lower receive power. If the DCI indicates that the UE should wake up, the UE wakes up its full receiver circuitry for the next DRX_ON duration 62. Otherwise the UE can go to sleep following the PS-PDCCH and does not have to decode other PDCCH during the DRX_ON duration 62.

At the time of filing of the present disclosure, 3GPP has started a study item [5] on low power receivers and low power wake-up signals for NR-5G. The justification of this study, as described in section 3 of [5], is reproduced below.

5G systems are designed and developed targeting for both mobile telephony and vertical use cases. Besides latency, reliability, and availability, UE energy efficiency is also critical to 5G. Currently, 5G devices may have to be recharged per week or day, depending on an individual's usage time. In general, 5G devices consume tens of milliwatts in RRC idle/inactive state and hundreds of milliwatts in RRC connected state. Designs to prolong battery life therefore are a necessity for improving energy efficiency as well as for providing a better user experience.

Energy efficiency is even more critical for UEs without a continuous energy source, e.g., UEs using small rechargeable and single coin cell batteries. Among vertical use cases, sensors and actuators are deployed extensively for monitoring, measuring, charging, etc. Generally, their batteries are not rechargeable and are expected to last for at least a few years. Such UEs may be wearable devices which may include smart watches, rings, eHealth related devices, and medical monitoring devices. With typical battery capacities, it is challenging to sustain power for up to one or two weeks as required.

The power consumption depends on the configured length of wake-up periods, e.g., on the paging cycle. To meet the battery life requirements noted above, eDRX cycles of long durations are expected to be used, resulting in high latency, which is not suitable for services with requirements of both long battery life and low latency. For example, in fire detection and extinguishment use cases, fire shutters should be closed and fire sprinklers should be turned on by the actuators within one or two seconds from the time the fire is detected by sensors; a long eDRX cycle therefore cannot meet the delay requirements. eDRX thus appears not to be suitable for latency-critical use cases. Therefore, the intention is to study ultra-low power mechanisms that can support low latency in Rel-18, e.g. lower than eDRX latency.

Currently, UEs need to periodically wake up once per DRX cycle, which dominates the power consumption in periods with no signalling or data traffic. If UEs are able to wake up only when they are triggered, e.g. via paging, power consumption could be dramatically reduced. This can be achieved by using a wake-up signal (WUS)—as described above—to trigger the main radio, and a separate receiver at the UE which has the ability to monitor for wake-up signals with ultra-low power consumption without needing to power-up the main radio (MR). The MR works for data transmission and reception, and can be turned off or set to deep sleep unless it is turned on.

The power consumption for monitoring wake-up signal depends on the wake-up signal design and the hardware module of the wake-up receiver used for wake-up signal detection and processing. The study in [5] is to primarily target low-power WUS and wake-up receiver (WUR) for power-sensitive, small form-factor devices including IoT use cases (such as industrial sensors, controllers) and wearable devices. Other use cases are not precluded, e.g. eXtended Reality (XR)/smart glasses, smart phones, etc.

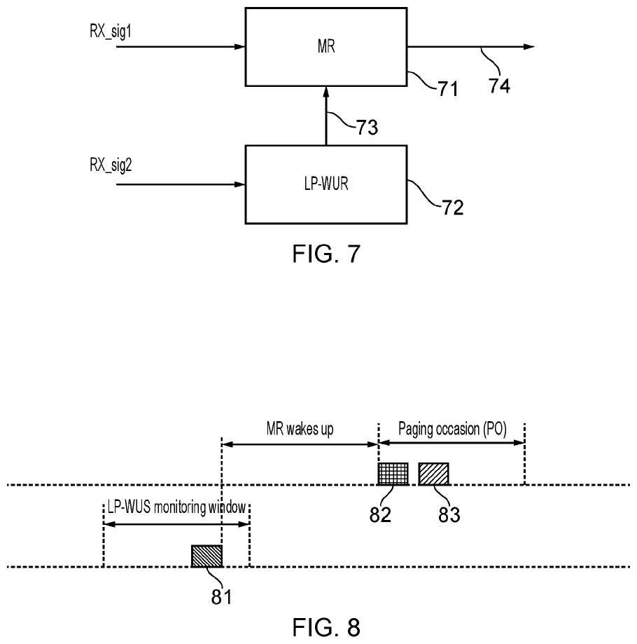

The goal is hence to support a low power wake up signal (LP-WUS) that is received by a low power wake-up receiver (LP-WUR). If the LP-WUR detects an LP-WUS, the main receiver (MR) of the UE is woken up and the MR can then decode the data that is transmitted by the network. FIG. 7 shows the relationship between the MR 71 and LP-WUR 72 of a UE.

The LP-WUR 72 receives a signal, RX_sig2, and monitors for LP-WUS within RX sig2. If the LP-WUR 72 detects an LP-WUS, it wakes up the MR 71 via, for example an “ON/OFF” indication 73. The MR 71 then decodes its input signal, RX_sig1, and receives data 74 which can then be forwarded to the UE's buffers or processors or the like. In some cases, RX_sig2 is the same as RX_sig1. For example, RX_sig1 and RX_sig2 can refer to the system bandwidth of an NR waveform. In other cases, RX_sig1 and RX_sig2 are different. For example, RX_sig1 could be the system bandwidth of an NR waveform and RX_sig2 could be a narrower bandwidth in or out of band signal.

In IDLE mode, the LP-WUS could be used to wake up the MR so that the UE can monitor a paging occasion (PO). That is:
If an LP-WUS is detected, the UE wakes up MR and the UE decodes the PO; or
If an LP-WUS is not detected, the MR is not woken up.

FIG. 8 shows the case where an LP-WUS 81 is used to wake an IDLE mode UE up to monitor for a paging message during a paging occasion (PO). The LP-WUR of the UE monitors for an LP-WUS 81 during an LP-WUS monitoring window. The LP-WUR of the UE knows that if the network were to transmit an LP-WUS 81, it would be transmitted during the LP-WUS monitoring window. Hence, the LP-WUR only needs to actively monitor for LP-WUS 81 during this LP-WUS monitoring window. If LP-WUS 81 is detected, the LP-WUR wakes the MR up (those skilled in the art would appreciate that this process may take some time, for example 100 ms). The MR then monitors for PDCCH 82 during the paging occasion. If the UE receives a PDSCH 83 containing its identifier during the PO, the UE performs an initial access procedure with the network. During the time that the MR wakes up, the MR needs to synchronise with the network and potentially read system information. It should be appreciated here that if an LP-WUS is not detected, the LP-WUR does not need to wake up the MR.

Some LP-WUR architectures have sufficiently low power consumption that they can be “ON” all the time. Other LP-WURs have a higher power consumption, or are implemented in UEs which require lower power consumption, and it is therefore advantageous for those LP-WUR to only monitor for LP-WUS in an LP-WUS monitoring window (i.e. in a DRX-like fashion).

In order to be of low cost and to operate with a low power consumption, the LP-WUR may operate with the following characteristics:
The LP-WUR may have a clock with poor frequency accuracy. Operation with a ring oscillator, rather than a crystal oscillator, will reduce power consumption, as well as cost and complexity. The ring oscillator will have lower frequency accuracy and higher timing drift than the oscillator for the MR. The MR clock is typically based on a crystal oscillator. The frequency and/or timing of the ring oscillator can be reset to the MR clock when the MR is awake (i.e. “on”). The MR clock is synchronised to the gNB using phase locked loops or the like to track the synchronisation signal block (SSB). When the MR is inactive, the MR clock is powered down; at such a time, the LP-WUR needs to rely on its own ring oscillator as the high-accuracy MR clock can no longer be used.
The LP-WUS may use a different waveform to the NR waveform. This waveform may not require synchronisation to the NR waveform's synchronisation signals (e.g. SSB and demodulation reference signals (DMRS)).

The inaccuracy of the LP-WUR clock relative to the gNB's clock means that the UE would need to turn on for monitoring the LP-WUS monitoring window earlier by a time equal to the maximum inaccuracy between the gNB and UE clocks, so as to ensure that it does not miss receiving an LP-WUS in the case that the LP-WUS is transmitted right at the end of the monitoring window in combination with the LP-WUR's timing having drifted by the maximum amount.

The UE would be designed with some knowledge of the maximum potential inaccuracy of its clock (e.g. the frequency error of its clock). The UE can use this information to determine the maximum inaccuracy of its LP-WUR clock. For example, consider the case where the maximum time drift rate between the LP-WUR clock and the gNB clock is ±T_{drift}_{_{_}}_{^{rate}}. If the LP-WUS monitoring window occurs every T_{DRX} seconds, the LP-WUR clock will have developed a timing inaccuracy of T_{drift}_{_{_}}_{^{rate}}×T_{DRX} after the first LP-WUS monitoring window, 2×T_{drift}_{_{_}}_{^{rate}}×T_{DRX} after the second LP-WUS monitoring window etc. The LP-WUR will hence have to be “on” for increasingly longer and longer times to ensure that the LP-WUR is actually on for the duration of the LP-WUS transmission window (where the LP-WUS transmission window is a time window during which the gNB might transmit LP-WUS. In the case that the UE clock is perfectly synchronised to the gNB, the UE's LP-WUS monitoring window is the same as the gNB's LP-WUS transmission window); this will of course increase the average power consumption of the LP-WUR, since it will spend longer in the “on” state.

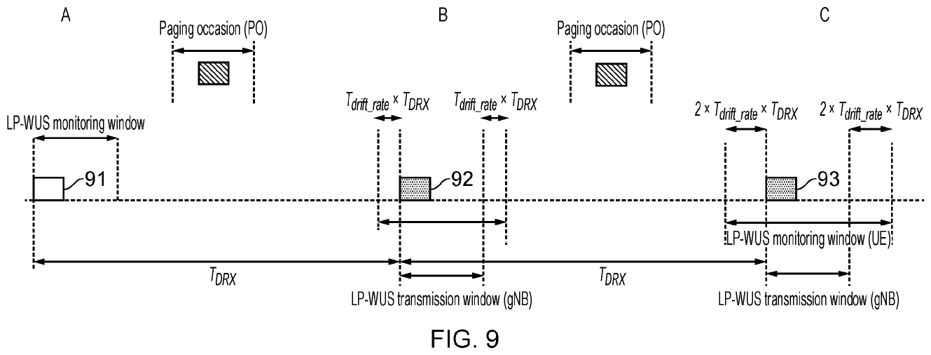

The effect of time drift on the length of the LP-WUS monitoring window is shown in FIG. 9. In FIG. 9, three LP-WUS monitoring windows are shown. The LP-WUS monitoring windows are described with reference to the instances A, B and C.
A: The LP-WUR is operating in a manner where its LP-WUS monitoring window is synchronised with the gNB's LP-WUS transmission window. For example, the UE might have recently been operating with its main radio “on”, in which case it will have obtained an accurate synchronisation with the gNB's clock. In this case, the UE monitoring window for the LP-WUS is the same as the LP-WUS transmission window at the gNB (where this LP-WUS transmission window is a window of time in which the gNB may transmit an LP-WUS 91 prior to a paging occasion-where the gNB may transmit a PDCCH and PDSCH during the paging occasion for the UE or another UE);
B: The LP-WUR has been running on an inaccurate oscillator that is not synchronised to the gNB. The inaccuracy of the oscillator means that there is an uncertainty at the UE about the location of the gNB's LP-WUS transmission window (wherein in instance B, no LP-WUS 92 is transmitted). The UE has to hence extend its LP-WUS monitoring window by a pre-cursor amount of time, T_{drift}_{_{_}}_{^{rate}}×T_{DRX} and continue for a post-cursor amount of time T_{drift}_{_{_}}_{^{rate}}×T_{DRX}. This extension of the UE's LP-WUS monitoring window ensures that the UE's inaccurately timed LP-WUS monitoring window overlaps with the gNB's LP-WUS transmission window;
C: Since the LP-WUR hasn't been re-synchronised since A (and again no LP-WUS 93 is transmitted in instance C either), the possible timing error between the UE and the gNB may have increased by a further amount of time, T_{drift}_{_{_}}_{^{rate}}×T_{DRX}. Hence, the UE's LP-WUS monitoring window has to start by a pre-cursor amount of time, 2×T_{drift}_{_{_}}_{^{rate}}×T_{DRX} and continue for a post-cursor amount of time 2×T_{drift}_{_{_}}_{^{rate}}×T_{DRX}.

As can be seen from the discussion above and from FIG. 9, the duration of the LP-WUR's LP-WUS monitoring window needs to increase as the potential timing error of the LP-WUR builds up. The potential timing error at the UE builds up as the time since the last re-synchronisation of the LP-WUR increases. A consequence of the LP-WUR's LP-WUS monitoring window increasing is that the LP-WUR will consume more average power (the LP-WUR will be “on” for a greater proportion of the LP-WUS DRX cycle), and this problem will perpetuate for as long a time as the UE and/or LP-WUR has not resynchronised with the network.

The LP-WUR timing can be re-synchronised when either:
The LP-WUR detects an LP-WUS, where the LP-WUS has a structure that allows accurate timing to be derived; or
The UE turns on its main radio and synchronises to the main 5G NR signal (i.e. synchronises to the SSB). The updated timing information obtained by the MR can then be transferred to the LP-WUR.

A technical problem to solve is hence how to provide means for the LP-WUR to be able to minimise its timing uncertainty such that it can reduce the size of its LP-WUS monitoring window, and hence save average power consumption. Embodiments of the present technique therefore seek to provide solutions to address such a problem.

### Low Power Wake-Up Signal Synchronisation

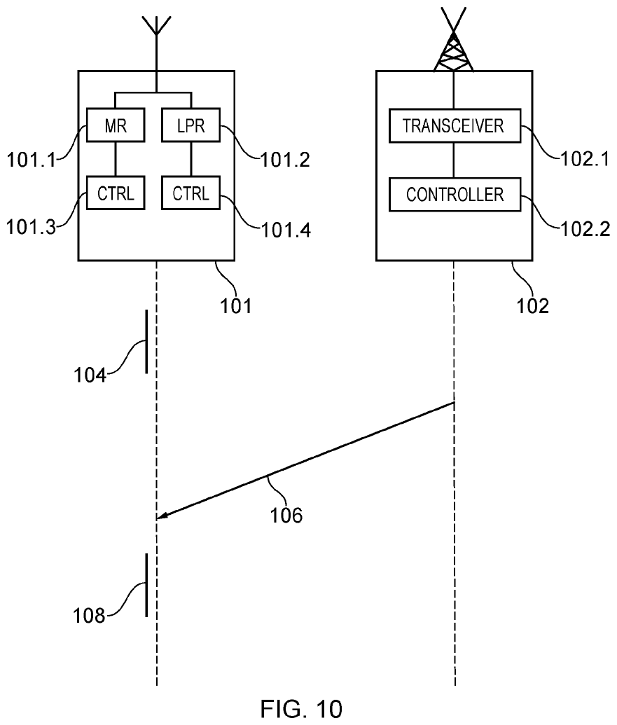

FIG. 10 shows a part schematic, part message flow diagram representation of a wireless communications system comprising a communications device (e.g. UE) 101 and an infrastructure equipment (e.g. gNB) 102 in accordance with at least some embodiments of the present technique. The communications device 101 is configured to transmit signals to and/or receive signals from the wireless communications network, for example, to and from the infrastructure equipment 102. Specifically, the communications device 101 may be configured to transmit data to and/or receive data from the wireless communications network (e.g. to/from the infrastructure equipment 102) via a wireless radio interface provided by the wireless communications network (e.g. a Uu interface between the communications device 101 and the Radio Access Network (RAN), which includes the infrastructure equipment 102). The communications device 101 comprises a main receiver (or main receiver circuitry) 101.1, a low-power receiver (or low-power receiver circuitry) 101.2 and at least one controller (or controller circuitry) 101.3, 101.4, while the infrastructure equipment 102 comprises a transceiver (or transceiver circuitry) 102.1, and a controller (or controller circuitry) 102.2. Each of the controllers 101.3, 101.4, 102.2 may be, for example, a microprocessor, a CPU, or a dedicated chipset, etc. In the example of FIG. 10, two controllers 101.3, 101.4 are shown, with a first controller 101.3 operatively coupled to (and hence controlling) the main receiver 101.1, and a second controller 101.4 operatively coupled to (and hence controlling) the low-power receiver 101.2. Those skilled in the art would appreciate that this would be advantageous given that the main CPU (e.g. controller 101.3) of the communications device 101 may be more powerful than a CPU (e.g. controller 101.4) connected to the low-power receiver 101.2 and would consume a lot of power if it needed to be on so as to control the low-power receiver 101.2. Of course those skilled in the art would appreciate that in some arrangements of embodiments of the present technique, the communications device 101 may comprise a single controller (or controller circuitry) used to control both of the main receiver 101.1 and the low-power receiver 101.2.

As shown in the example of FIG. 10, the at least one controller 101.3, 101.4 of the communications device 101 is configured to control the communications device 101 to determine 104 whether or not the communications device 101 is to monitor for a first signal from the wireless communications network (e.g. from the infrastructure equipment 102), wherein the first signal comprises an indication of timing information of the wireless communications network (e.g. timing information of the infrastructure equipment 102), to receive 106, if the communications device 101 determines it is to monitor for the first signal, the first signal from the wireless communications network (e.g. from the infrastructure equipment 102) via the low-power receiver 101.2 (LPR/LP-WUR) while the low-power receiver 101.2 is in an on state and the main receiver (MR) 101.1 is in an off state, and to synchronise 108 the communications device 101 with the wireless communications network (e.g. with the infrastructure equipment 102) based on the timing information of the wireless communications network (e.g. the timing information of the infrastructure equipment 102). Here, a power consumption of the low-power receiver 101.2 when the low-power receiver 101.2 is in the on state is lower than a power consumption of the main receiver 101.1 when the main receiver 101.1 is in the on state.

Essentially, embodiments of the present technique therefore propose that the gNB sends a signal (which may be a signal with an LP-WUS or LP-WUS like structure) to the LP-WUR, allowing the LP-WUR to re-synchronise its timing with the gNB. Re-synchronisation of the LP-WUR does not require the UE's main radio (MR) to be switched on, as the LP-WUS-like signal can be received or decoded by the LP-WUR. In accordance with embodiments of the present technique as described herein, this signal may be an actual LP-WUS or a modified LP-WUS, or indeed any signal with an LP-WUS-like structure or some other structure that enables it to be received and decoded by the LP-WUR without involvement of the MR, and may be interchangeably referred to as a first signal, an LP-WUS, or a re-synchronisation (or re-sync) LP-WUS.

In some arrangements of embodiments of the present technique, the UE's LP-WUR synchronises to the received LP-WUS, but the LP-WUS does not wake up the UE (in other words, does not wake up the UE's MR). In such arrangements of embodiments of the present technique (as well as in other arrangements of embodiments of the present technique) it is assumed that the LP-WUS has a structure that allows the LP-WUR to synchronise to it. Those skilled in the art would appreciate that such a signal differs from certain known signals in NR and eMTC, such as the wake-up signal (WUS) which indicates that a UE should wake up, the go-to-sleep signal (GTS) which indicates that a UE should go to sleep (and/or not wake up) and a wake up and go to sleep signal (WGTS) which indicates that a UE should either wake up or go to sleep. The first signal/re-synchronisation LP-WUS/LP-WUS like signal described herein differs from these signals in terms of intention, as it neither indicates to the UE that it should go to sleep or wake up; but rather to allow the UE to synchronise with the network. In accordance with certain arrangements of embodiments of the present technique however, where such a first signal/re-synchronisation LP-WUS/LP-WUS like signal is received in conflict with a legacy type signal (e.g. WUS or GTS signal), then the UE would treat such legacy signals as having a higher priority and will overrule the first signal/re-synchronisation LP-WUS/LP-WUS like signal-of course, by receiving a WUS/GTS/WGTS signal and taking appropriate action, the UE would also synchronise with the network at the same time.

In some arrangements of embodiments of the present technique, the LP-WUS may contain a “wake-up” bit. The LP-WUS can contain a bit or flag with two states: e.g. (1) “wake-up” and (2) “do not wake up”. In other words, the LP-WUS may indicate (e.g. it may comprise a bit that indicates) whether or not the main receiver should switch from the off state to the on state in response to the low-power receiver receiving the LP-WUS signal-where here it may be the LP-WUR that determines to wake up the main receiver based on this indication/bit in the LP-WUS. If a UE has not been woken up for a long time and thus may require re-synchronisation, but does not need to be woken up for receipt of any other signalling or data, the gNB can send an LP-WUS with the bit set to “do not wake up”. By receiving the LP-WUS, the LP-WUR will re-synchronise to the gNB's clock and can hence reset its LP-WUS monitoring window to the gNB's LP-WUS transmission window. When the bit is set to “do not wake up”, the UE's LP-WUR can perform this re-synchronisation without going further to wake up its main receiver. In some such arrangements, this indication or bit may be understood not necessarily as a “wake-up or do not wake-up” bit, but rather as a bit included within an otherwise ordinary LP-WUS that overrules the normal function of the LP-WUS and indicates to the UE that actually the MR should not be woken up on receipt of this LP-WUS.

In some arrangements of embodiments of the present technique, the gNB may send an LP-WUS with an identity that does not match a particular UE that receives it. For an LP-WUS signal that contains a synchronisation sequence followed by some UE/LP-WUR identification, all UEs may synchronise to the synchronisation sequence even though at least some of those UEs do not wake up as the UE/LP-WUR identity does not match (i.e. it does not match one or more or all of those UEs that receive it). In other words, the LP-WUS may comprise an indication of one or more communications device identities, and wherein none of the one or more indicated communications device identities matches an identity of the communications device. In this case, sending the LP-WUS to any UE will allow all other UEs to re-synchronise. Hence, in such arrangements where the gNB does not need to wake up any of the UEs to which the LP-WUS is transmitted, the gNB sends the LP-WUS with an identity that does not match any UE. This will allow all UEs to synchronise to the LP-WUS, but no UEs would actually wake their main receiver.

In some arrangements of embodiments of the present technique, the gNB may rotate the UEs that are woken up just for re-synchronisation purposes. In a similar vein to the arrangements described in the paragraph above, the gNB can send an LP-WUS to several UEs with an identity of a UE (UE_A) that actually wakes that UE_A up. The said UE_A would wake up and turn its main radio on. However, the LP-WURs of the other UEs to which the LP-WUS is transmitted would re-synchronise to the same synchronisation sequence. Although in this case UE_A was woken when it didn't need to be woken up, at a future time another UE, UE_B, would be woken up. Hence the pain of incorrectly waking UEs up, just to allow other UEs'LP-WURs to re-synchronise, can be shared between multiple UEs. In other words, the LP-WUS may indicate (e.g. through comprising an identifier of the communications device) that the communications device is to switch its main receiver from the off state to the on state in response to the low-power receiver receiving the LP-WUS signal, and wherein the infrastructure equipment may be configured to transmit the LP-WUS to the communications device and one or more other communications devices according to a rotating schedule determined by the infrastructure equipment. Here, it should be appreciated that if the gNB determines that it may need to wake a specific UE (i.e. wake the MR of that UE) for another purpose, such as transmitting control signalling or data to that UE, then the gNB may move that UE to the back of the queue of the rotating schedule so as to avoid having to wake that UE up again in too recent a time.

In some arrangements of embodiments of the present technique, the gNB may send a broadcast LP-WUS that is recognised by a group of UEs (e.g. UEs that support LP-WUS or a selected group of UEs within those UEs that support LP-WUS). The said broadcast LP-WUS may have a known sequence that indicates to the UEs to use it merely for re-synchronisation purposes, and that the UEs do not need to wake up their MRs. In other words, the LP-WUS signal may be received from the wireless communications network as a broadcast signal broadcasted to the communications device and to one or more other communications devices, wherein the broadcasted LP-WUS comprises an indication that the main receiver is not to switch from the off state to the on-state in response to the low-power receiver receiving the broadcasted LP-WUS signal.

If the LP-WUR has not been woken up for multiple DRX cycles, and if the timing drift at the UE is sufficiently large, the timing error at the UE may become greater than the time it takes to transmit an LP-WUS. In this case, even if the LP-WUR synchronises to the LP-WUS, it does not know where that LP-WUS is located in the gNB's LP-WUS transmission window, and hence cannot determine the start and end times of the gNB's LP-WUS transmission window. Accordingly, to address this issue, in some arrangements of embodiments of the present technique, the LP-WUS may indicate where within the LP-WUS transmission window it is transmitted.

In some arrangements of embodiments of the present technique, a bit sequence in LP-WUS may identify a position of the LP-WUS or LP-WUS-like signal in the LP-WUS transmission window. The bit sequence may indicate the time index of the LP-WUS in the LP-WUS transmission window. In other words, the indication of the timing information of the wireless communications network may comprise a sequence of one or more bits indicating a time index of the first signal within a transmission window during which the first signal may be transmitted by the wireless communications network-where here this transmission window is the window during which the UE's LP-WUR should be switched on to monitor for LP-WUS signals (though of course, with respect to the timing drift of the UE, the on period of the LP-WUR may be shifted in time with respect to the transmission window, hence necessitating the indication of the time index of the LP-WUS within the transmission window).

In some arrangements of embodiments of the present technique, the time index could indicate the position (e.g. subframe/slot/sub-slot number) of the start of the LP-WUS transmission. In other words, the time index of the first signal within the transmission window may be a starting position of the first signal within the transmission window. Alternatively, the end of the LP-WUS transmission could be indicated. In other words, the time index of the first signal within the transmission window may be an ending position of the first signal within the transmission window.

In some arrangements of embodiments of the present technique, the time index could indicate the index of the LP-WUS transmission. If it is known (by the UEs as well as the network) that the LP-WUS transmission window has space in time for the transmission of a certain number N of LP-WUS signals, the index can indicate in which of the N LP-WUS transmission opportunities the LP-WUS had been transmitted. In other words, the transmission window may comprise a plurality of possible locations of the first signal, and the time index of the first signal within the transmission window may be the one of the plurality of possible locations of the first signal in which the first signal is transmitted by the wireless communications network. For example, if the LP-WUS transmission window is 16 slots long, and each LP-WUS has a duration of two slots, there is space for N=8 LP-WUS. If the index is enumerated from 0 to 7, and the index indicates “1”, the LP-WUR would understand that the LP-WUS had been transmitted in the second index, i.e. two (2×“1”=2) slots after the start of the LP-WUS transmission window. The LP-WUR would then be able adjust its LP-WUS monitoring window to start two slots prior to the time that it had received the LP-WUS.

In some arrangements of embodiments of the present technique, a bit sequence in LP-WUS may identify a position of the LP-WUS or LP-WUS-like signal relative to the start of the paging occasion. The bit sequence may indicate a time index of the LP-WUS relative to the start of the paging occasion. In other words, the indication of the timing information of the wireless communications network may comprise a sequence of one or more bits indicating a time index of the first signal relative to the start of a paging occasion associated with the communications device.

In some arrangements of embodiments of the present technique, a synchronisation sequence may identify the position of the LP-WUS or LP-WUS-like signal in the LP-WUS transmission window. LP-WUS signals transmitted at different times in the LP-WUS transmission window may therefore use different synchronisation sequences. In other words, the indication of the timing information of the wireless communications network may comprise a synchronisation sequence used by the wireless communications network in transmitting the first signal, and the synchronisation sequence may be one of a plurality of possible synchronisation sequences which are each associated with one of a plurality of possible locations of the first signal within the transmission window. By synchronising to a particular synchronisation sequence, the UE is able to determine the location of the received LP-WUS in the LP-WUS transmission window, and is hence able to adjust the start of its LP-WUS monitoring window accordingly.

As those skilled in the art would appreciate, a downside of such arrangements as described in the paragraph above is that the UE would have to blind-decode for multiple LP-WUS synchronisation sequences, thereby increasing LP-WUR complexity and power consumption. It should be noted here a UE with a better timing drift could synchronise for fewer sequences, allowing for a design trade-off. For example, if the timing drift is small, the LP-WUR would know which synchronisation sequence or which subset of the synchronisation sequences may be active at a certain time. However, if the timing drift were larger, the LP-WUR might need to attempt synchronisation with more sequences, etc. The UE design could then trade-off timing drift requirements with requirements to attempt synchronisation with multiple sequences.

In some arrangements of embodiments of the present technique, a signal with an LP-WUS structure may be sent at certain (known) times to allow LP-WUR to synchronise to that signal. It should be noted that in this context—and indeed in the context of all arrangements of embodiments of the present technique as described herein—a signal with an “LP-WUS structure” is one that can be decoded by an LP-WUR. As an example, if the LP-WUR is based on an RF envelope detector, a signal with an LP-WUS structure may contain a synchronisation sequence that uses an on-off keying (OOK) waveform. The UE is able to synchronise to the signal with the LP-WUS structure. It should be appreciated by those skilled in the art that a UE/LP-WUR would normally monitor for LP-WUS in the LP-WUS monitoring period preceding its paging occasion (PO). However, different sets of UEs have different paging occasions. This means that if the gNB needs to send LP-WUS to re-synchronise LP-WUR/UEs (e.g. according to the above embodiments), it needs to send multiple LP-WUS in order to re-synchronise all the UEs that have the different paging occasions. Evidently, it would be more efficient for the gNB to send fewer (or indeed a single) LP-WUS to a set of UEs for re-synchronisation purposes, and hence the re-synchronisation signal (e.g. LP-WUS-like signal) may be sent by the gNB at certain times known to the UEs rather than preceding each UE's specific PO. Hence, all UEs can re-synchronise to the same re-synchronisation signal.

In some arrangements of embodiments of the present technique, a re-synchronisation LP-WUS signal may be sent at a known time (to the UE and to one or more other UEs at the same known time). For example, the transmission timing could be signalled in a system information block (SIB) or signalled to UEs in any suitable manner. When the UE re-synchronises to this signal, it knows the exact timing of the re-synchronisation LP-WUS signal. In other words, the communications device may be configured to determine that the first signal is to be transmitted by the wireless communications network at a specific time, and to monitor for the first signal at the specific time. Here, this known time may be based on the maximum timing drift which may be indicated by the UE to the network within UE capability information. In other words, the infrastructure equipment may be configured to receive, from the communications device while the communications device is in a connected state with the infrastructure equipment, capability information of the communications device, wherein the capability information of the communications device comprises an indication of a maximum drift rate of a clock of the communications device, and to determine the specific time based on the maximum drift rate of the clock of the communications device.

In some arrangements of embodiments of the present technique, a re-synchronisation LP-WUS signal may be transmitted within a window (to the UE and to one or more other UEs within the same known window). In other words, the communications device may be configured to determine that the first signal is to be transmitted by the wireless communications network within a specified time period, and to monitor for the first signal during the specified time period. Compared to the arrangements of embodiments of the present technique as described in the paragraph above, scheduling flexibility is provided to the gNB. It would be appreciated by those skilled in the art that the UE would have to determine where in the window the re-synchronisation LP-WUS signal had been transmitted (for example, according to one of the arrangements of embodiments of the present technique above relating to the LP-WUS comprising a bit sequence or synchronisation sequence indicating its position in the transmission window).

In some arrangements of embodiments of the present technique, a re-synchronisation LP-WUS signal may allow for mobility-related measurements. For example, the signal would indicate the cell in which it had been transmitted, allowing the UE to determine—by for example performing measurements on the received signal—whether it was still camped on a suitable cell or whether the UE should perform measurements on signals from neighbouring cells with a view to potentially performing a handover or other mobility procedure. In other words, the first signal comprises an indication of a cell of the wireless communications network from which it was transmitted.

In some arrangements of embodiments of the present technique, a gNB may send a re-synchronisation LP-WUS but the UE may itself decide whether or not to read it. Different UEs may have different clocks leading to different drift rates, T_{drift}_{_{_}}_{^{rate}}. A UE that has a better clock with a smaller T_{drift}_{_{_}}_{^{rate}} may benefit from less frequent re-synchronisation and hence save more power through not having to turn on its LP-WUR as frequently. In other words, the communications device may be configured to determine whether or not the communications device is to monitor for the first signal based on an accuracy of a clock of the communications device. Here, the gNB may send one re-synchronisation LP-WUS periodically, targeting for example the fastest T_{drift}_{_{_}}_{^{rate}}, which may be unnecessary for UEs with more accurate clocks. Hence in such arrangements of embodiments of the present technique, the UE can decide when to read the re-synchronisation LP-WUS. It should be noted here that all UEs must be aware of the periodicity of the re-synchronisation LP-WUS in order to know when to attempt to receive it and when to skip receipt/decoding of it. It should also be noted here that such arrangements of embodiments of the present technique are applicable when a re-sync LP-WUS is known to be sent at a different time to a “real LP-WUS” (i.e. one that requires the UE to wake-up by switching on the MR because it needs to receive a PDCCH or PDSCH or the like from the gNB).

In at least some arrangements of embodiments of the present technique, the gNB may periodically broadcast a re-sync LP-WUS to a group of UEs. Here the gNB may not need to make any determination as to whether each of the UEs in the group needs to re-synchronise or not, but instead the UE can decide whether to read the re-sync LP-WUS, e.g. based on its clock accuracy as described above, or if the UE determines it is already synchronised, or last synchronised an acceptable amount of time ago, as is described in the paragraphs below. In other words, the infrastructure equipment may be configured to periodically transmit, to one or more communications devices, a first signal comprising an indication of timing information of the infrastructure equipment for use by the one or more communications devices in synchronising the one or more communications devices with the infrastructure equipment based on the timing information of the infrastructure equipment, Here, the infrastructure equipment may be configured to periodically transmit the first signal to a low-power receiver of each of the one or more communications devices while the low-power receiver of each communications device is in an on state and a main receiver of each communications device is in an off state, and wherein a power consumption of the low-power receiver of each communications device when the low-power receiver of each communications device is in the on state is lower than a power consumption of the main receiver of each communications device when the main receiver of each communications device is in the on state.

In some arrangements of embodiments of the present technique the gNB may only send an LP-WUS for synchronisation purposes when it knows that UEs/LP-WURs may not otherwise be synchronised. As those skilled in the art would appreciate, there are time instants at which the UE/LP-WUR has to wake up anyway. In waking up at such time instants, the UE/LP-WUR will regain synchronisation and will hence be able to reset its LP-WUS monitoring window. The gNB hence does not need to send LP-WUS for synchronisation purposes close to such times as this would unnecessarily require the switching on of the UE's LP-WUR, consuming unnecessary power. In other words, the infrastructure equipment may be configured to determine whether or not the communications needs to synchronise with the infrastructure equipment based on a length of time since the communications device last synchronised with the infrastructure equipment, and to determine, if the infrastructure equipment determines that the communications device does not need to synchronise with the infrastructure equipment, that the infrastructure equipment is to skip transmission of the first signal to the communications device. Here, this length of time may be a length of time fixed in the specifications and known to the UE, indicated in any appropriate manner by the network to the UE (where in some examples it may be determined by the network based on the UE indicating its maximum drift rate within UE capability information to the network, providing this is done while the UE is in CONNECTED mode), or otherwise determined by the UE.

It would also be appreciated by those skilled in the art that if the gNB skips transmission of the re-synchronisation LP-WUS at certain times (or, indeed, even if it doesn't) and the UE is itself aware that it has synchronised with the network recently enough, the UE may decide to skip monitoring for that re-synchronisation LP-WUS at such certain times. In other words, the communications device may be configured to determine whether or not the communications device is to monitor for the first signal based on a length of time since the communications device last synchronised with the wireless communications network.

In some arrangements of embodiments of the present technique, the UE may have recently synchronised with the network based on receipt of a system information update. UEs will have to read system information when certain system information is updated. There is hence no need for the gNB to send LP-WUS to re-synchronise UEs/LP-WUR or for the UE to monitor for such re-synchronisation LP-WUS after reception of such updated system information. In other words, the infrastructure equipment may be configured to determine that the communications device last synchronised with the infrastructure equipment based on the infrastructure equipment transmitting system information update to the communications device, and/or the communications device may be configured to determine that it last synchronised with the wireless communications network based on receiving system information from the wireless communications network.

In some arrangements of embodiments of the present technique, the UE may have recently performed mobility measurements. There are times at which UEs need to perform mobility measurements. In order to perform mobility measurements, the UE/LP-WUR will need to synchronise to the network (here, the measurements could be performed by the MR based on the 5G NR signal or may be performed by the LP-WUR based on the LP-WUS signal, but in either case the UE will have synchronised with the network). There is hence no need for the gNB to send LP-WUS to re-synchronise UEs/LP-WUR or for the UE to monitor for such re-synchronisation LP-WUS after transmission of signals required for mobility measurements. In other words, the infrastructure equipment may be configured to determine that the communications device last synchronised with the infrastructure equipment based on determining that the communications device has performed mobility measurements with respect to the wireless communications network, and/or the communications device may be configured to determine that it last synchronised with the wireless communications network based on performing mobility measurements with respect to the wireless communications network.

In some arrangements of embodiments of the present technique, the gNB may have recently performed a signalling/data transmission to the UE (where this might include RRC control signalling, or data, or control information via a PDCCH or a PDSCH, etc.), or the UE may correspondingly have recently performed a transmission to the gNB. If the gNB has recently sent signals to the UE (for example to start/end an RRC connection), the UE will have recently been synchronised to the gNB and there will be no need for the gNB to send an LP-WUS signal to allow that UE to re-synchronise with the network or for the UE to monitor for such re-synchronisation LP-WUS. In other words, the infrastructure equipment may be configured to determine that the communications device last synchronised with the infrastructure equipment based on the infrastructure equipment transmitting control information and/or downlink data to the communications device, and/or the communications device may be configured to determine that it last synchronised with the wireless communications network based on receiving control information and/or downlink data from the wireless communications network.

In some arrangements of embodiments of the present technique, the UE may independently wake up its main radio if it determines that its clock may have drifted to a large extent. If the UE/LP-WUR considers that its clock may have drifted to a large extent (and/or it has not synchronised for more than a threshold amount of time) or that its LP-WUS monitoring window is too large, the LP-WUR can indicate that the UE's main radio should wake up in order to re-synchronise to the network. Once the UE's main radio has re-synchronised, the start point of the LP-WUR's monitoring window can be reset and the UE's main radio can return to a sleep mode. In other words, the communications device may be configured to determine, based on determining that a clock of the communications device may have drifted in time by greater than a threshold amount, that the communications device needs to synchronise with the wireless communications network, to switch the main receiver to an on state, to receive, from the wireless communications network, one or more synchronisation signals via the main receiver while the main receiver is in the on state, wherein the one or more synchronisation signals comprise timing information of the wireless communications network, to synchronise (e.g. the main receiver of) the communications device with the wireless communications network based on the timing information of the wireless communications network, and to switch the main receiver to the off state. Here, the threshold amount may be fixed in the specifications and known to the UE, indicated in any appropriate manner by the network to the UE, or otherwise determined by the UE. Furthermore, here, where the main receiver is first synchronised via the timing information indicated by the synchronisation signals, the communications device may then also synchronise its low-power receiver based on the now-synchronised main receiver telling it what the current timing is (where the LP-WUR's clock may automatically synchronise as it is itself derived from the MR's clock) before the MR returns to the off state.

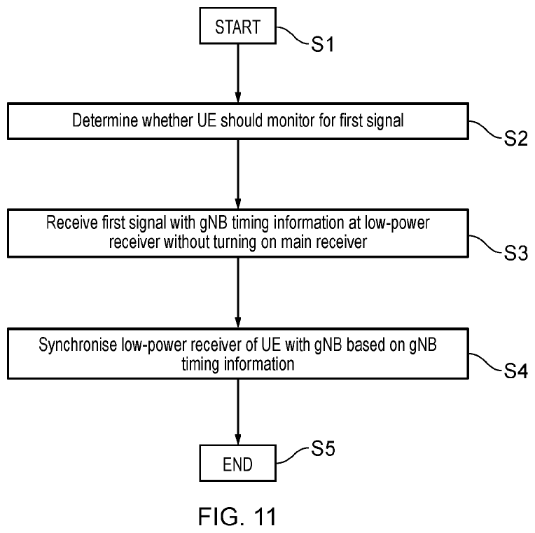

FIG. 11 shows a flow diagram illustrating an example process of communications in a communications system in accordance with embodiments of the present technique. The process shown by FIG. 11 is a method of operating a communications device comprising a low-power receiver and a main receiver (where a power consumption of the low-power receiver when the low-power receiver is in the on state is lower than a power consumption of the main receiver when the main receiver is in the on state).

The method begins in step S1. The method comprises, in step S2, determining whether or not the communications device is to monitor for a first signal from a wireless communications network, wherein the first signal comprises an indication of timing information of the wireless communications network. In step S3, the method comprises receiving, if the communications device determines it is to monitor for the first signal, the first signal from the wireless communications network via the low-power receiver while the low-power receiver is in an on state and the main receiver is in an off state. Then, in step S4, the process comprises synchronising the communications device (e.g. the low-power receiver of the communications device) with the wireless communications network based on the timing information of the wireless communications network. The process ends in step S4.

Those skilled in the art would appreciate that the method shown by FIG. 11 may be adapted in accordance with embodiments of the present technique. For example, other intermediate steps may be included in this method, or the steps may be performed in any logical order. Though embodiments of the present technique have been described largely by way of the example communications system shown in FIG. 10, it would be clear to those skilled in the art that they could be equally applied to other systems to those described herein.

Those skilled in the art would further appreciate that such infrastructure equipment and/or communications devices as herein defined may be further defined in accordance with the various arrangements and embodiments discussed in the preceding paragraphs. It would be further appreciated by those skilled in the art that such infrastructure equipment and communications devices as herein defined and described may form part of communications systems other than those defined by the present disclosure.

The following numbered paragraphs provide further example aspects and features of the present technique:

Paragraph 1. A method of operating a communications device comprising a low-power receiver and a main receiver, the method comprising
determining whether or not the communications device is to monitor for a first signal from a wireless communications network, wherein the first signal comprises an indication of timing information of the wireless communications network,
receiving, if the communications device determines it is to monitor for the first signal, the first signal from the wireless communications network via the low-power receiver while the low-power receiver is in an on state and the main receiver is in an off state, and
synchronising the communications device with the wireless communications network based on the timing information of the wireless communications network,
wherein a power consumption of the low-power receiver when the low-power receiver is in the on state is lower than a power consumption of the main receiver when the main receiver is in the on state.

Paragraph 2. A method according to Paragraph 1, wherein the first signal is a low-power wake-up signal, LP-WUS.

Paragraph 3. A method according to Paragraph 2, wherein the LP-WUS indicates whether or not the main receiver should switch from the off state to the on state in response to the low-power receiver receiving the LP-WUS signal.

Paragraph 4. A method according to Paragraph 2 or Paragraph 3, wherein the LP-WUS comprises an indication of one or more communications device identities, and wherein none of the one or more indicated communications device identities matches an identity of the communications device.

Paragraph 5. A method according to any of Paragraphs 2 to 4, wherein the LP-WUS signal is received from the wireless communications network as a broadcast signal broadcasted to the communications device and to one or more other communications devices, wherein the broadcasted LP-WUS comprises an indication that the main receiver is not to switch from the off state to the on-state in response to the low-power receiver receiving the broadcasted LP-WUS signal.

Paragraph 6. A method according to any of Paragraphs 1 to 5, wherein the indication of the timing information of the wireless communications network comprises a sequence of one or more bits indicating a time index of the first signal within a transmission window during which the first signal may be transmitted by the wireless communications network.

Paragraph 7. A method according to Paragraph 6, wherein the time index of the first signal within the transmission window is a starting position of the first signal within the transmission window.

Paragraph 8. A method according to Paragraph 6 or Paragraph 7, wherein the time index of the first signal within the transmission window is an ending position of the first signal within the transmission window.

Paragraph 9. A method according to any of Paragraphs 6 to 8, wherein the transmission window comprises a plurality of possible locations of the first signal, and wherein the time index of the first signal within the transmission window is the one of the plurality of possible locations of the first signal in which the first signal is transmitted by the wireless communications network.

Paragraph 10. A method according to any of Paragraphs 1 to 9, wherein the indication of the timing information of the wireless communications network comprises a sequence of one or more bits indicating a time index of the first signal relative to a paging occasion associated with the communications device.

Paragraph 11. A method according to any of Paragraphs 1 to 10, wherein the indication of the timing information of the wireless communications network comprises a synchronisation sequence used by the wireless communications network in transmitting the first signal, and wherein the synchronisation sequence is one of a plurality of possible synchronisation sequences which are each associated with one of a plurality of possible locations of the first signal within the transmission window.

Paragraph 12. A method according to any of Paragraphs 1 to 11, comprising determining that the first signal is to be transmitted by the wireless communications network at a specific time, and monitoring for the first signal at the specific time.

Paragraph 13. A method according to any of Paragraphs 1 to 12, comprising determining that the first signal is to be transmitted by the wireless communications network within a specified time period, and monitoring for the first signal during the specified time period.

Paragraph 14. A method according to any of Paragraphs 1 to 13, wherein the first signal comprises an indication of a cell of the wireless communications network from which it was transmitted.

Paragraph 15. A method according to any of Paragraphs 1 to 14, wherein the communications device determines whether or not the communications device is to monitor for the first signal based on an accuracy of a clock of the communications device.

Paragraph 16. A method according to any of Paragraphs 1 to 15, wherein the communications device determines whether or not the communications device is to monitor for the first signal based on a length of time since the communications device last synchronised with the wireless communications network.

Paragraph 17. A method according to Paragraph 16, wherein the communications device determines that it last synchronised with the wireless communications network based on receiving system information from the wireless communications network.

Paragraph 18. A method according to Paragraph 16 or Paragraph 17, wherein the communications device determines that it last synchronised with the wireless communications network based on performing mobility measurements with respect to the wireless communications network.

Paragraph 19. A method according to any of Paragraphs 16 to 18, wherein the communications device determines that it last synchronised with the wireless communications network based on receiving control information and/or downlink data from the wireless communications network.

Paragraph 20. A communications device comprising
a low-power receiver,
a main receiver, and
at least one controller configured to control the communications device
to determine whether or not the communications device is to monitor for a first signal from a wireless communications network, wherein the first signal comprises an indication of timing information of the wireless communications network,
to receive, if the communications device determines it is to monitor for the first signal, the first signal from the wireless communications network via the low-power receiver while the low-power receiver is in an on state and the main receiver is in an off state, and
to synchronise the communications device with the wireless communications network based on the timing information of the wireless communications network,
wherein a power consumption of the low-power receiver when the low-power receiver is in the on state is lower than a power consumption of the main receiver when the main receiver is in the on state.

Paragraph 21. Circuitry for a communications device comprising
low-power receiver circuitry,
main receiver circuitry, and
at least one controller circuitry configured to control the communications device
to determine whether or not the communications device is to monitor for a first signal from a wireless communications network, wherein the first signal comprises an indication of timing information of the wireless communications network,
to receive, if the communications device determines it is to monitor for the first signal, the first signal from the wireless communications network via the low-power receiver circuitry while the low-power receiver circuitry is in an on state and the main receiver circuitry is in an off state, and
to synchronise the communications device with the wireless communications network based on the timing information of the wireless communications network,
wherein a power consumption of the low-power receiver circuitry when the low-power receiver circuitry is in the on state is lower than a power consumption of the main receiver circuitry when the main receiver circuitry is in the on state.

Paragraph 22. A method of operating an infrastructure equipment forming part of a wireless communications network, the method comprising
determining whether or not a communications device needs to synchronise with the infrastructure equipment, and
transmitting to the communications device, if the infrastructure equipment determines that the communications device needs to synchronise with the infrastructure equipment, a first signal comprising an indication of timing information of the infrastructure equipment for use by the communications device in synchronising the communications device with the infrastructure equipment based on the timing information of the infrastructure equipment,
wherein the method comprises transmitting the first signal to a low-power receiver of the communications device while the low-power receiver of the communications device is in an on state and a main receiver of the communications device is in an off state, and wherein a power consumption of the low-power receiver of the communications device when the low-power receiver of the communications device is in the on state is lower than a power consumption of the main receiver of the communications device when the main receiver of the communications device is in the on state.

Paragraph 23. A method according to Paragraph 22, wherein the first signal is a low-power wake-up signal, LP-WUS.

Paragraph 24. A method according to Paragraph 23, wherein the LP-WUS indicates whether or not the communications device should switch its main receiver from the off state to the on state in response to the low-power receiver receiving the LP-WUS signal.

Paragraph 25. A method according to Paragraph 23 or Paragraph 24, wherein the LP-WUS comprises an indication of one or more communications device identities, and wherein none of the one or more indicated communications device identities matches either an identity of the communications device or identities of one or more other communications devices to which the infrastructure equipment transmits the LP-WUS.

Paragraph 26. A method according to any of Paragraphs 23 to 25, wherein the LP-WUS indicates that the communications device is to switch its main receiver from the off state to the on state in response to the low-power receiver receiving the LP-WUS signal, and wherein the method comprises
transmitting the LP-WUS to the communications device and one or more other communications devices according to a rotating schedule determined by the infrastructure equipment.

Paragraph 27. A method according to any of Paragraphs 23 to 26, comprising
broadcasting the LP-WUS signal to the communications device and to one or more other communications devices each comprising a low-power receiver and a main receiver, wherein the broadcasted LP-WUS comprises an indication that the communications device and the one or more other communications devices are not to switch their main receivers from the off state to the on-state in response to receiving the broadcasted LP-WUS signal.

Paragraph 28. A method according to any of Paragraphs 22 to 27, wherein the indication of the timing information of the infrastructure equipment comprises a sequence of one or more bits indicating a time index of the first signal within a transmission window during which the first signal may be transmitted by the infrastructure equipment.

Paragraph 29. A method according to Paragraph 28, wherein the time index of the first signal within the transmission window is a starting position of the first signal within the transmission window.

Paragraph 30. A method according to Paragraph 28 or Paragraph 29, wherein the time index of the first signal within the transmission window is an ending position of the first signal within the transmission window.

Paragraph 31. A method according to any of Paragraphs 28 to 30, wherein the transmission window comprises a plurality of possible locations of the first signal, and wherein the time index of the first signal within the transmission window is the one of the plurality of possible locations of the first signal in which the first signal is transmitted by the infrastructure equipment.

Paragraph 32. A method according to any of Paragraphs 22 to 31, wherein the indication of the timing information of the infrastructure equipment comprises a sequence of one or more bits indicating a time index of the first signal relative to a paging occasion associated with the communications device.

Paragraph 33. A method according to any of Paragraphs 22 to 32, wherein the indication of the timing information of the infrastructure equipment comprises a synchronisation sequence used by the infrastructure equipment in transmitting the first signal, and wherein the synchronisation sequence is one of a plurality of possible synchronisation sequences which are each associated with one of a plurality of possible locations of the first signal within the transmission window.

Paragraph 34. A method according to any of Paragraphs 22 to 33, comprising
transmitting the first signal at a specific time known to the communications device.

Paragraph 35. A method according to Paragraph 34, comprising
receiving, from the communications device while the communications device is in a connected state with the infrastructure equipment, capability information of the communications device, wherein the capability information of the communications device comprises an indication of a maximum drift rate of a clock of the communications device, and
determining the specific time based on the maximum drift rate of the clock of the communications device.

Paragraph 36. A method according to any of Paragraphs 22 to 35, comprising
transmitting the first signal within a specified time period known to the communications device.

Paragraph 37. A method according to any of Paragraphs 22 to 36, wherein the first signal comprises an indication of a cell of the wireless communications network, the cell being a cell controlled by the infrastructure equipment.

Paragraph 38. A method according to any of Paragraphs 22 to 37, wherein the infrastructure equipment determines whether or not the communications device needs to synchronise with the infrastructure equipment based on a length of time since the communications device last synchronised with the infrastructure equipment, and wherein the method comprises
determining, if the infrastructure equipment determines that the communications device does not need to synchronise with the infrastructure equipment, that the infrastructure equipment is to skip transmission of the first signal to the communications device.

Paragraph 39. A method according to Paragraph 38, wherein the infrastructure equipment determines that the communications device last synchronised with the infrastructure equipment based on the infrastructure equipment transmitting system information to the communications device.

Paragraph 40. A method according to Paragraph 38 or Paragraph 39, wherein the infrastructure equipment determines that the communications device last synchronised with the infrastructure equipment based on determining that the communications device has performed mobility measurements with respect to the wireless communications network.

Paragraph 41. A method according to any of Paragraphs 38 to 40, wherein the infrastructure equipment determines that the communications device last synchronised with the infrastructure equipment based on the infrastructure equipment transmitting control information and/or downlink data to the communications device.

Paragraph 42. An infrastructure equipment forming part of a wireless communications network, the infrastructure equipment comprising
transceiver circuitry, and
controller circuitry configured in combination with the transceiver circuitry
to determine whether or not a communications device needs to synchronise with the infrastructure equipment, and
to transmit to the communications device, if the infrastructure equipment determines that the communications device needs to synchronise with the infrastructure equipment, a first signal comprising an indication of timing information of the infrastructure equipment for use by the communications device in synchronising the communications device with the infrastructure equipment based on the timing information of the infrastructure equipment,
wherein the method comprises transmitting the first signal to a low-power receiver of the communications device while the low-power receiver of the communications device is in an on state and a main receiver of the communications device is in an off state, and wherein a power consumption of the low-power receiver of the communications device when the low-power receiver of the communications device is in the on state is lower than a power consumption of the main receiver of the communications device when the main receiver of the communications device is in the on state.

Paragraph 43. Circuitry for an infrastructure equipment forming part of a wireless communications network, the infrastructure equipment comprising
transceiver circuitry, and
controller circuitry configured in combination with the transceiver circuitry
to determine whether or not a communications device needs to synchronise with the infrastructure equipment, and
to transmit to the communications device, if the infrastructure equipment determines that the communications device needs to synchronise with the infrastructure equipment, a first signal comprising an indication of timing information of the infrastructure equipment for use by the communications device in synchronising the communications device with the infrastructure equipment based on the timing information of the infrastructure equipment,
wherein the method comprises transmitting the first signal to a low-power receiver of the communications device while the low-power receiver of the communications device is in an on state and a main receiver of the communications device is in an off state, and wherein a power consumption of the low-power receiver of the communications device when the low-power receiver of the communications device is in the on state is lower than a power consumption of the main receiver of the communications device when the main receiver of the communications device is in the on state.

Paragraph 44. A wireless communications system comprising a communications device according to Paragraph 20 and an infrastructure equipment according to Paragraph 42.

Paragraph 45. A computer program comprising instructions which, when loaded onto a computer, cause the computer to perform a method according to any of Paragraphs 1 to 19 or Paragraphs 22 to 41.

Paragraph 46. A non-transitory computer-readable storage medium storing a computer program according to Paragraph 45.

Paragraph 47. A method of operating a communications device comprising a low-power receiver and a main receiver, the method comprising
determining, based on determining that a clock of the communications device has drifted in time by greater than a threshold amount, that the communications device needs to synchronise with a wireless communications network,
switching the main receiver to an on state,
receiving, from the wireless communications network, one or more synchronisation signals via the main receiver while the main receiver is in the on state, wherein the one or more synchronisation signals comprise timing information of the wireless communications network,
synchronising the communications device with the wireless communications network based on the timing information of the wireless communications network, and
switching the main receiver to the off state,
wherein a power consumption of the low-power receiver when the low-power receiver is in the on state is lower than a power consumption of the main receiver when the main receiver is in the on state.

Paragraph 48. A communications device comprising
a low-power receiver,
a main receiver, and
at least one controller configured to control the communications device
to determine, based on determining that a clock of the communications device has drifted in time by greater than a threshold amount, that the communications device needs to synchronise with a wireless communications network,
to switch the main receiver to an on state,
to receive, from the wireless communications network, one or more synchronisation signals via the main receiver while the main receiver is in the on state, wherein the one or more synchronisation signals comprise timing information of the wireless communications network,
to synchronise the communications device with the wireless communications network based on the timing information of the wireless communications network, and
to switch the main receiver to the off state,
wherein a power consumption of the low-power receiver when the low-power receiver is in the on state is lower than a power consumption of the main receiver when the main receiver is in the on state.

Paragraph 49. Circuitry for a communications device comprising
low-power receiver circuitry,
main receiver circuitry, and
at least one controller circuitry configured to control the communications device
to determine, based on determining that a clock of the communications device has drifted in time by greater than a threshold amount, that the communications device needs to synchronise with a wireless communications network,
to switch the main receiver to an on state,
to receive, from the wireless communications network, one or more synchronisation signals via the main receiver while the main receiver is in the on state, wherein the one or more synchronisation signals comprise timing information of the wireless communications network,
to synchronise the communications device with the wireless communications network based on the timing information of the wireless communications network, and
to switch the main receiver to the off state,
wherein a power consumption of the low-power receiver when the low-power receiver is in the on state is lower than a power consumption of the main receiver when the main receiver is in the on state.

Paragraph 50. A computer program comprising instructions which, when loaded onto a computer, cause the computer to perform a method according to Paragraph 47.

Paragraph 51. A non-transitory computer-readable storage medium storing a computer program according to Paragraph 50.

Paragraph 52. A method of operating an infrastructure equipment forming part of a wireless communications network, the method comprising
periodically transmitting, to one or more communications devices, a first signal comprising an indication of timing information of the infrastructure equipment for use by the one or more communications devices in synchronising the one or more communications devices with the infrastructure equipment based on the timing information of the infrastructure equipment,
wherein the method comprises periodically transmitting the first signal to a low-power receiver of each of the one or more communications devices while the low-power receiver of each communications device is in an on state and a main receiver of each communications device is in an off state, and wherein a power consumption of the low-power receiver of each communications device when the low-power receiver of each communications device is in the on state is lower than a power consumption of the main receiver of each communications device when the main receiver of each communications device is in the on state.

Paragraph 53. An infrastructure equipment forming part of a wireless communications network, the infrastructure equipment comprising
transceiver circuitry, and
controller circuitry configured in combination with the transceiver circuitry
to periodically transmit, to one or more communications devices, a first signal comprising an indication of timing information of the infrastructure equipment for use by the one or more communications devices in synchronising the one or more communications devices with the infrastructure equipment based on the timing information of the infrastructure equipment,
wherein the method comprises periodically transmitting the first signal to a low-power receiver of each of the one or more communications devices while the low-power receiver of each communications device is in an on state and a main receiver of each communications device is in an off state, and wherein a power consumption of the low-power receiver of each communications device when the low-power receiver of each communications device is in the on state is lower than a power consumption of the main receiver of each communications device when the main receiver of each communications device is in the on state.

Paragraph 54. Circuitry for an infrastructure equipment forming part of a wireless communications network, the infrastructure equipment comprising
transceiver circuitry, and
controller circuitry configured in combination with the transceiver circuitry
to periodically transmit, to one or more communications devices, a first signal comprising an indication of timing information of the infrastructure equipment for use by the one or more communications devices in synchronising the one or more communications devices with the infrastructure equipment based on the timing information of the infrastructure equipment,
wherein the method comprises periodically transmitting the first signal to a low-power receiver of each of the one or more communications devices while the low-power receiver of each communications device is in an on state and a main receiver of each communications device is in an off state, and wherein a power consumption of the low-power receiver of each communications device when the low-power receiver of each communications device is in the on state is lower than a power consumption of the main receiver of each communications device when the main receiver of each communications device is in the on state.

Paragraph 55. A computer program comprising instructions which, when loaded onto a computer, cause the computer to perform a method according to Paragraph 52.

Paragraph 56. A non-transitory computer-readable storage medium storing a computer program according to Paragraph 55.

It will be appreciated that the above description for clarity has described embodiments with reference to different functional units, circuitry and/or processors. However, it will be apparent that any suitable distribution of functionality between different functional units, circuitry and/or processors may be used without detracting from the embodiments.

Described embodiments may be implemented in any suitable form including hardware, software, firmware or any combination of these. Described embodiments may optionally be implemented at least partly as computer software running on one or more data processors and/or digital signal processors. The elements and components of any embodiment may be physically, functionally and logically implemented in any suitable way. Indeed, the functionality may be implemented in a single unit, in a plurality of units or as part of other functional units. As such, the disclosed embodiments may be implemented in a single unit or may be physically and functionally distributed between different units, circuitry and/or processors.

Although the present disclosure has been described in connection with some embodiments, it is not intended to be limited to the specific form set forth herein. Additionally, although a feature may appear to be described in connection with particular embodiments, one skilled in the art would recognise that various features of the described embodiments may be combined in any manner suitable to implement the technique.

### REFERENCES

[1] Holma H. and Toskala A, “LTE for UMTS OFDMA and SC-FDMA Based Radio Access”, John Wiley and Sons, 2009.
[2] TR 38.913, “3^{rd} Generation Partnership Project; Technical Specification Group Radio Access Network; Study on Scenarios and Requirements for Next Generation Access Technologies (Release 14)”, 3GPP, v14.3.0, August 2017.
[3] R1-1708311, “Idle Mode Power Efficiency Reduction,” Sierra Wireless, RAN1#89.
[4] TR 38.840, “NR: Study on UE Power Saving (Release 16, v0.1.0)”, 3GPP, November 2018.
[5] RP-222644, “Revised SID: Study on low-power Wake-up Signal and Receiver for NR”, RANP#97e, September 2022.

1. A method of operating a communications device comprising a low-power receiver and a main receiver, the method comprising
determining whether or not the communications device is to monitor for a first signal from a wireless communications network, wherein the first signal comprises an indication of timing information of the wireless communications network,
receiving, if the communications device determines it is to monitor for the first signal, the first signal from the wireless communications network via the low-power receiver while the low-power receiver is in an on state and the main receiver is in an off state, and
synchronising the communications device with the wireless communications network based on the timing information of the wireless communications network,
wherein a power consumption of the low-power receiver when the low-power receiver is in the on state is lower than a power consumption of the main receiver when the main receiver is in the on state.

2. A method according to claim 1, wherein the first signal is a low-power wake-up signal, LP-WUS.

3. A method according to claim 2, wherein the LP-WUS indicates whether or not the main receiver should switch from the off state to the on state in response to the low-power receiver receiving the LP-WUS signal.

4. A method according to claim 2, wherein the LP-WUS comprises an indication of one or more communications device identities, and wherein none of the one or more indicated communications device identities matches an identity of the communications device.

5. A method according to claim 2, wherein the LP-WUS signal is received from the wireless communications network as a broadcast signal broadcasted to the communications device and to one or more other communications devices, wherein the broadcasted LP-WUS comprises an indication that the main receiver is not to switch from the off state to the on-state in response to the low-power receiver receiving the broadcasted LP-WUS signal.

6. A method according to claim 1, wherein the indication of the timing information of the wireless communications network comprises a sequence of one or more bits indicating a time index of the first signal within a transmission window during which the first signal may be transmitted by the wireless communications network.

7. A method according to claim 6, wherein the time index of the first signal within the transmission window is a starting position of the first signal within the transmission window.

8. A method according to claim 6, wherein the time index of the first signal within the transmission window is an ending position of the first signal within the transmission window.

9. A method according to claim 6, wherein the transmission window comprises a plurality of possible locations of the first signal, and wherein the time index of the first signal within the transmission window is the one of the plurality of possible locations of the first signal in which the first signal is transmitted by the wireless communications network.

10. A method according to claim 1, wherein the indication of the timing information of the wireless communications network comprises a sequence of one or more bits indicating a time index of the first signal relative to a paging occasion associated with the communications device.

11. A method according to claim 1, wherein the indication of the timing information of the wireless communications network comprises a synchronisation sequence used by the wireless communications network in transmitting the first signal, and wherein the synchronisation sequence is one of a plurality of possible synchronisation sequences which are each associated with one of a plurality of possible locations of the first signal within the transmission window.

12. A method according to claim 1, comprising
determining that the first signal is to be transmitted by the wireless communications network at a specific time, and
monitoring for the first signal at the specific time.

13. A method according to claim 1, comprising
determining that the first signal is to be transmitted by the wireless communications network within a specified time period, and
monitoring for the first signal during the specified time period.

14. A method according to claim 1, wherein the first signal comprises an indication of a cell of the wireless communications network from which it was transmitted.

15. A method according to claim 1, wherein the communications device determines whether or not the communications device is to monitor for the first signal based on an accuracy of a clock of the communications device.

16. A method according to claim 1, wherein the communications device determines whether or not the communications device is to monitor for the first signal based on a length of time since the communications device last synchronised with the wireless communications network.

17. A method according to claim 16, wherein the communications device determines that it last synchronised with the wireless communications network based on receiving system information from the wireless communications network.

18. A method according to claim 16, wherein the communications device determines that it last synchronised with the wireless communications network based on performing mobility measurements with respect to the wireless communications network.

19.-20. (canceled)

21. Circuitry for a communications device comprising
low-power receiver circuitry,
main receiver circuitry, and
at least one controller circuitry configured to control the communications device
to determine whether or not the communications device is to monitor for a first signal from a wireless communications network, wherein the first signal comprises an indication of timing information of the wireless communications network,
to receive, if the communications device determines it is to monitor for the first signal, the first signal from the wireless communications network via the low-power receiver circuitry while the low-power receiver circuitry is in an on state and the main receiver circuitry is in an off state, and
to synchronise the communications device with the wireless communications network based on the timing information of the wireless communications network,
wherein a power consumption of the low-power receiver circuitry when the low-power receiver circuitry is in the on state is lower than a power consumption of the main receiver circuitry when the main receiver circuitry is in the on state.

22.-42. (canceled)

43. Circuitry for an infrastructure equipment forming part of a wireless communications network, the infrastructure equipment comprising
transceiver circuitry, and
controller circuitry configured in combination with the transceiver circuitry
to determine whether or not a communications device needs to synchronise with the infrastructure equipment, and
to transmit to the communications device, if the infrastructure equipment determines that the communications device needs to synchronise with the infrastructure equipment, a first signal comprising an indication of timing information of the infrastructure equipment for use by the communications device in synchronising the communications device with the infrastructure equipment based on the timing information of the infrastructure equipment,
wherein the method comprises transmitting the first signal to a low-power receiver of the communications device while the low-power receiver of the communications device is in an on state and a main receiver of the communications device is in an off state, and wherein a power consumption of the low-power receiver of the communications device when the low-power receiver of the communications device is in the on state is lower than a power consumption of the main receiver of the communications device when the main receiver of the communications device is in the on state.

44.-56. (canceled)
